(19) United States
(12) Patent Application Publication
(10) Pub. No.: US 2025/0180360 A1
(43) Pub. Date: Jun. 5, 2025

(54) INFORMATION PROCESSING APPARATUS, METHOD, AND STORAGE MEDIUM

(71) Applicant: CANON KABUSHIKI KAISHA, Tokyo (JP)

(72) Inventor: SHOKO MIURA, Tokyo (JP)

(21) Appl. No.: 18/953,221

(22) Filed: Nov. 20, 2024

(30) Foreign Application Priority Data
Dec. 4, 2023 (JP) 2023-204422
Aug. 6, 2024 (JP) 2024-129681

(51) Int. Cl. G01C 21/20; G01C 21/00; G01S 17/89

(52) U.S. Cl. CPC G01C 21/206; G01C 21/3837; G01S 17/89

(57) ABSTRACT

In an information processing apparatus that creates a map of an environment in which a movable apparatus moves, a material distribution in an environment in which the movable apparatus moves is acquired, a measurement value measured by a sensor disposed on the movable apparatus is acquired, and a map of the environment is creating based on the measurement value and the material distribution.

### CROSS-REFERENCE TO PRIORITY APPLICATIONS

This application claims the benefit of priority from Japanese Patent Application No. 2023-204422, filed on Dec. 4, 2023, and Japanese Patent Application No. 2024-129681, filed on Aug. 6, 2024, both of which are hereby incorporated by reference herein in its entirety.

### BACKGROUND OF THE INVENTION

### Field of the Invention

The present invention relates to an information processing apparatus, a method, and a storage medium.

### Description of the Related Art

During estimation of the self-position and orientation of an autonomously traveling movable apparatus, an environment map is created in advance and used. The accuracy of the environment map referred to during autonomous traveling greatly affects the estimation accuracy of the self-position and orientation.

In Japanese Patent No. 7,079,568, a position estimation device is proposed, in which, when construction data is used as an environment map at a construction site, a construction completed object at that time is extracted from the construction data so that an environment map that matches a construction object at the construction site in the middle of construction taking into consideration the order of construction is obtained, and a self-position is estimated.

Japanese Patent No. 7,079,568, however, has a drawback in which the accuracy of the map is low depending on the material of a surrounding object.

### SUMMARY OF THE INVENTION

An information processing apparatus in one embodiment of the present invention is an information processing apparatus that creates a map of an environment in which a movable apparatus moves, acquires a material distribution in an environment in which the movable apparatus moves, acquires a measurement value measured by a sensor disposed on the movable apparatus, and creates a map of the environment based on the measurement value and the material distribution.

Further features of the present invention will become apparent from the following description of embodiments with reference to the attached drawings.

### BRIEF DESCRIPTION OF THE DRAWINGS

FIG. 1 is a diagram showing a use environment of an information processing apparatus according to the first embodiment of the present invention.

FIG. 2 is a functional block diagram of a system according to the first embodiment of the present invention.

FIG. 3 is a block diagram showing a hardware configuration of an information processing apparatus 100 according to the first embodiment of the present invention.

FIG. 4 is a flowchart explaining an operation of the information processing apparatus 100 according to the first embodiment of the present invention.

FIG. 5 is a flowchart explaining an operation of a map creation unit 230 in the information processing apparatus 100 according to the first embodiment of the present invention.

FIG. 6 is a functional block diagram of a system according to the second embodiment of the present invention.

FIG. 7 is a diagram showing a display example according to the second embodiment of the present invention.

FIG. 8 is a functional block diagram of a system according to the third embodiment of the present invention.

FIG. 9 is a flowchart explaining the operation of the information processing apparatus 100 according to the third embodiment of the present invention.

FIG. 10 is a flowchart explaining an operation of the map creation path determination unit 810 of the information processing apparatus 100 according to the third embodiment of the present invention.

FIG. 11 is a diagram showing an example of a GUI displayed by the notification unit 820 according to the third embodiment of the present invention.

FIG. 12 is a functional block diagram of a system according to the sixth embodiment of the present invention.

FIG. 13 is a flowchart explaining the operation of the information processing apparatus 100 according to the sixth embodiment of the present invention.

FIG. 14 is a flowchart explaining an operation of the presentation content control unit 1201 in the information processing apparatus 100 according to the sixth embodiment of the present invention.

FIGS. 15A and 15B are diagrams showing an example of a GUI displayed by a second notification unit 1203 according to the sixth embodiment of the present invention.

FIG. 16 is a diagram showing an example of a GUI displayed by the second notification unit 1203 according to a modification of the sixth embodiment of the present invention.

FIG. 17 is a flowchart explaining the operation of the information processing apparatus 100 according to the seventh embodiment of the present invention.

FIG. 18 is a flowchart explaining an operation of a material distribution acquisition unit 210 according to the seventh embodiment of the present invention.

### DESCRIPTION OF THE EMBODIMENTS

Hereafter, with reference to the accompanying drawings, favorable modes of the present invention will be described using Embodiments. In each diagram, the same reference signs are applied to the same members or elements, and duplicate description will be omitted or simplified.

### First Embodiment

In the first embodiment, an information processing apparatus that creates an environment map for a movable apparatus to estimate its own position and orientation will be described. It is assumed that a 2D LiDAR serving as a measurement sensor is mounted on the movable apparatus in the first embodiment, and an environment map is created by using a measurement value obtained by the 2D LiDAR.

LiDAR is an abbreviation for “Light Detection and Ranging”. Note that in the explanation below, the environment map may be referred to as a map.

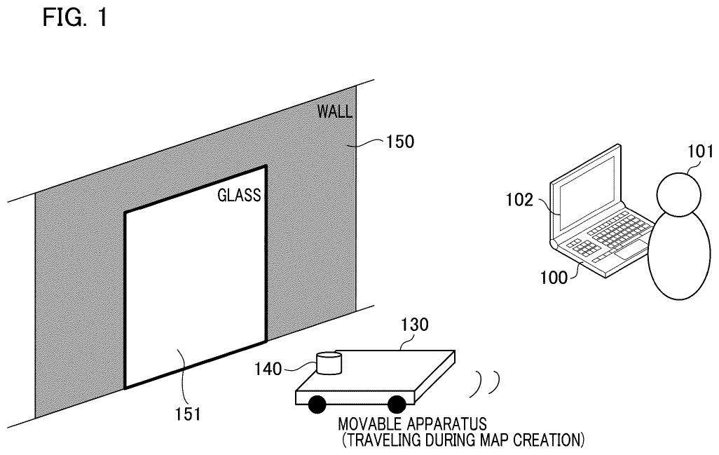

FIG. 1 is a diagram showing a use environment of an information processing apparatus according to the first embodiment of the present invention. FIG. 1 shows a manner in which a movable apparatus 130 is traveling through an area where a wall 150 having a glass 151 is present. The movable apparatus 130 has a sensor 140 and travels to create an environment map.

The movable apparatus 130 travels while being manually controlled by a user. The information processing apparatus 100 receives information such as a measurement value of the sensor 140 from the movable apparatus 130 and creates the environment map. The information processing apparatus 100 is integrated with a display device 102, and is operated by a user 101. The information processing apparatus 100 causes the display device 102 to display the created environmental map.

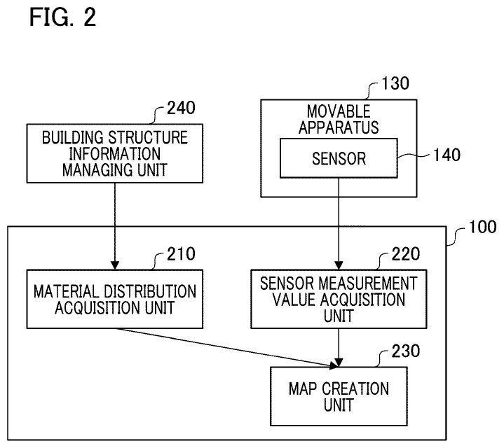

FIG. 2 is a functional block diagram of a system according to the first embodiment of the present invention. Note that the functional blocks as shown in FIG. 2 need not be incorporated in the same housing, and may be configured by separate devices connected to each other via a signal path.

The information processing apparatus 100 includes the material distribution acquisition unit 210, a sensor measurement value acquisition unit 220, and the map creation unit 230. The material distribution acquisition unit 210 acquires a material distribution in an environment in which the movable apparatus 130 travels. The sensor measurement value acquisition unit 220 acquires a measurement value of the sensor 140. The map creation unit 230 creates an environment map.

The material distribution acquisition unit 210 acquires a material distribution, which includes the information on the type and distribution of the material, around the movable apparatus 130 under the environment in which the movable apparatus 130 travels, from a building structure information managing unit 240. The building structure information managing unit 240 may be provided in, for example, an external server.

The sensor measurement value acquisition unit 220 acquires a sensor measurement value measured by the sensor 140 disposed on the movable apparatus 130. The map creation unit 230 predicts a measurement error of the sensor based on the material distribution that has been acquired by the material distribution acquisition unit 210 and the sensor measurement value that has been acquired by the sensor measurement value acquisition unit 220, and creates an environment map by using the sensor measurement value based on the predicted measurement error.

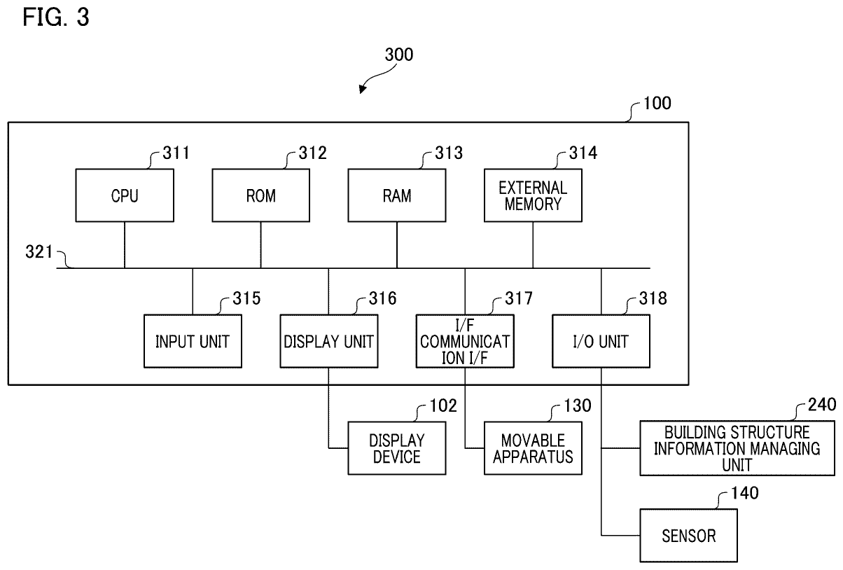

FIG. 3 is a block diagram showing a hardware configuration of the information processing apparatus 100. The information processing apparatus 100 has a CPU 311, a ROM 312, a RAM 313, an external memory 314, an input unit 315, a display unit 316, a communication I/F 317, an I/O unit 318, and a system bus 321.

CPU is an abbreviation for “Central Processing Unit”. ROM is an abbreviation for “Read Only Memory”. RAM is an abbreviation for “Random Access Memory”.

I/F is an abbreviation for “interface”. I/O is an abbreviation for “Input/Output”. The CPU 311, the ROM 312, the RAM 313, the external memory 314, the input unit 315, the display unit 316, the communication I/F 317, and the I/O unit 318 are connected to the system bus 321.

The CPU 311 functions as a control unit that controls the operation of each unit connected to the system bus 321 based on a computer program stored in a memory (ROM 312 and the like) serving as a storage medium. The ROM 312 stores a BIOS program, a boot program, and other computer programs.

BIOS is an abbreviation for “Basic Input Output System”. The RAM 313 is used as the main storage unit of the CPU 311. The external memory 314 is an external memory including an HDD and an SSD, and stores a program processed by the information processing apparatus 100. HDD is an abbreviation for “Hard Disk Drive”. SSD is an abbreviation for “Solid State Drive”.

The input unit 315 performs processing related to input of information and the like from a keyboard, a mouse, and the like. The display unit 316 outputs a calculation result of the information processing apparatus 100 to the display apparatus 102 according to an instruction from the CPU 311. Note that the display device 102 may be of any type, such as a liquid crystal display device, a projector, and an LED indicator.

The communication I/F 317 is an interface related to communication. The communication I/F 317 performs information communications via a network, and sends and receives information to and from the movable apparatus 130. The communication I/F 317 may be Ethernet (registered trademark), and may be any type of communication such as USE, serial communications, and wireless communications.

USB is an abbreviation for “Universal Serial Bus”. The communication I/F 317 also communicates with an external server and stores various kinds of data in the external server. The I/O unit 318 inputs the distribution information of the surrounding material under the environment in which the movable apparatus 130 travels from the building structure information managing unit 240 and the sensor measurement value measured by the sensor 140. Additionally, the I/O unit 318 outputs the environment map that has been created by the map creation unit 230.

The functional blocks as shown in FIG. 2 are realized by the CPU 311 serving as a computer executing a computer program stored in a memory (the ROM 312, the external memory 314, and the like) serving as a storage medium.

Note that some or all of the functional blocks as shown in FIG. 2 may be realized by hardware. As the hardware, a dedicated circuit (ASIC), a processor (reconfigurable processor, DSP), and the like can be used.

ASIC is an abbreviation for “Application Specific Integrated Circuit”. DSP is an abbreviation for “Digital Signal Processor”.

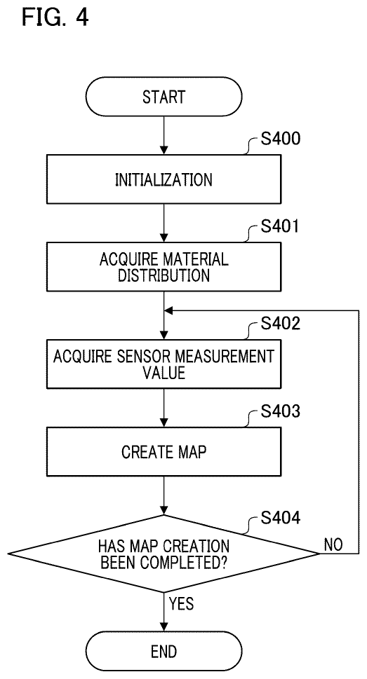

FIG. 4 is a flowchart explaining the operation of the information processing apparatus 100. Hereinafter, the flowchart is realized by the CPU 311 executing a computer program stored in a memory (ROM 312 and the like) serving as a storage medium. The timing at which the information processing apparatus 100 according to the first embodiment starts the operation is a timing at which the movable apparatus 130 starts measurement for map creation.

In step S400, the information processing apparatus 100 performs initialization process for acquiring parameters necessary for the processing according to the first embodiment. In the first embodiment, the information processing apparatus 100 acquires the sensor measurement error information for each material type measured by the sensor 140 mounted on the movable apparatus 130, and the coordinate conversion information for associating the coordinate system of the material distribution and the coordinate system at which the sensor measurement value is acquired.

The sensor 140 is a 2D LiDAR, which is a distance measurement sensor that measures a distance to an object by scanning laser light horizontally at equal angular intervals. The sensor measurement error information for each material measured by the sensor 140 is a ratio of a distance measurement result obtained when the sensor 140 actually measures a distance to a member of the material with respect to a true value of the distance between the member of the material and the sensor.

In the first embodiment, an ID (hereinafter referred to as a “material ID”) is assigned to each manufacturer and model number of a material, and a ratio of a distance measurement result with respect to a true value of a distance between a material member and a sensor is tabulated for each material ID to obtain a sensor measurement error information table.

The material distribution coordinate system is a coordinate system (building coordinate system) associated with the building structure managed by the building structure information managing unit 240. In contrast, the coordinate system in which the sensor measurement value is measured is the coordinate system in real space. The coordinate conversion information is information for associating the two coordinate systems.

In step S401, the material distribution acquisition unit 210 acquires a material distribution around the movable apparatus 130 in an environment in which the movable apparatus 130 travels for creation of an environmental map from the building structure information managing unit 240. In the first embodiment, the building structure information managing unit 240 holds BIM information under an environment in which the movable apparatus 130 travels.

BIM is an abbreviation for “Building Information Modeling”. The BIM information also includes information on the building material, in addition to the three-dimensional model of the building structure. In the first embodiment, the material distribution acquisition unit 210 converts a parameter representing a shape of each configuring component of a building and the information on the building material of the building into a material ID and acquires the material ID.

The processes from step S402 to step S404 are repeatedly performed for each frame of the sensor measurement value that has been measured by the sensor 140. In the explanation below, a processing content in a frame of interest when the processing is repeatedly performed will be explained.

In step S402, the sensor measurement value acquisition unit 220 acquires a measurement value in the frame of interest that has been measured by the sensor 140. In the first embodiment, the sensor measurement value acquisition unit 220 acquires, as a sensor measurement value, a coordinate value of a point at which laser light is reflected in the real space coordinate system.

The coordinate value of the laser light reflection point in the real space can be calculated based on a distance from the point at which the laser light emitted from the sensor 140 is reflected to the sensor 140, the position and orientation information of the sensor 140 in the real space, and the direction of the emitted laser light. In the first embodiment, the sensor measurement value acquisition unit 220 acquires a result obtained by calculating the coordinate values of each reflection point measured in one frame in advance.

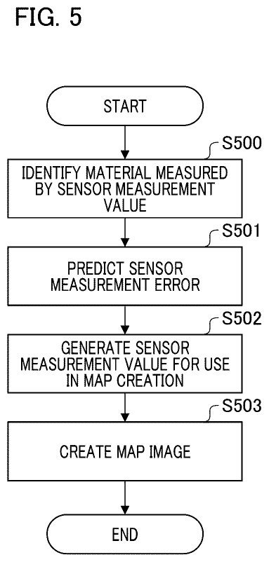

In step S403, the map creation unit 230 creates an environment map. A detailed processing flow of the environment map creation will be explained below with reference to FIG. 5.

In step S404, the information processing apparatus 100 determines whether or not to end the map creation. In the first embodiment, the information processing apparatus 100 determines to end the map creation in a case where the measurement of the range for which the environment map is to be created ends.

In a case where the information processing apparatus 100 determines to end the map creation, the process ends. If the information processing apparatus 100 determines not to end the map creation, that is, if the measurement is in progress, the process returns to step S402, the sensor measurement value is acquired again, and the processes from step S402 to step S404 are repeated.

FIG. 5 is a flowchart explaining the operation of the map creation unit 230 in the information processing apparatus 100 according to the first embodiment of the present invention. FIG. 5 illustrates details of the process in step S403 of FIG. 4.

In step S500, the map creation unit 230 identifies the material ID of the building material corresponding to each of the distance measurement results of the sensor measurement values in the frame of interest that have been acquired by the sensor measurement value acquisition unit 220 in step S402. The map creation unit 230 searches for a shape in which a line segments connecting the sensor position and the reflection point intersects, and identifies the material ID associated with a shape closest to the sensor position.

In step S501, the map creation unit 230 predicts a sensor measurement error. The map creation unit 230 refers to the sensor measurement error information table acquired in the initialization process in step S400, and acquires the sensor measurement error information corresponding to the material ID that has been identified in step S500. Additionally, the map creation unit 230 divides the distance measurement result by the sensor measurement error information and subtracts the distance measurement result to obtain a predicted value of the sensor measurement error.

In step S502, the map creation unit 230 generates a sensor measurement value used for map creation. In the first embodiment, it is determined whether or not to use the sensor measurement value acquired in step S402 for map creation according to the sensor measurement error predicted in step S501.

The map creation unit 230 sets a threshold for the sensor measurement error, and if the sensor measurement error at each measurement point in the frame is less than the threshold, the map creation unit 230 uses the sensor measurement value for map creation. If the sensor measurement error is equal to or greater than the threshold, the map creation unit 230 does not use the sensor measurement value for map creation.

In step S503, the map creation unit 230 creates a map data corresponding to the environmental map. The map creation unit 230 divides a space into grids and counts the sensor measurement values included in each grid. If the count number is equal to or greater than a predetermined threshold, the map creation unit 230 sets the value of the grid to “1”, indicating that an object is present.

If the count number is less than the threshold, the map creation unit 230 sets the value of the grid to “0”, indicating that no object is present. If the count number is zero, the map creation unit 230 sets “−1”, indicating that the measurement has not been performed. The value of the grid is an example of a map value associated with the spatial region corresponding to the measurement value.

The above is the map creation method in step S403.

According to the first embodiment, it is possible to create an environment map by excluding a sensor measurement value corresponding to materials such as glass and translucent plastic in which a large error may occur in sensor measurement, and it is possible to improve the accuracy of map creation. According to the first embodiment, since the accuracy of the map is improved, it is possible to improve the accuracy of the self-position estimation during the autonomous traveling of the movable apparatus 130.

Note that although in the first embodiment it has been explained that, for the material, the material ID is determined based on the manufacturer/model number, the present invention is not limited thereto. In the present embodiment, it suffices if the material ID is defined so as to correspond to the sensor measurement error information, and the material ID may be determined by the type of material, for example, glass, translucent plastic, and wallpaper.

In the first embodiment, in step S502, when the sensor measurement value to be used for map creation is generated, the map creation unit 230 sets a threshold for a sensor measurement error, and uses a sensor measurement value in which the sensor measurement error is smaller than the threshold.

However, in the present embodiment, the method of generating the sensor measurement value is not limited thereto. For example, the map creation unit 230 may generate a sensor measurement value weighted according to a sensor measurement error. In this case, if the sensor measurement error is large, the map creation unit 230 assigns a small weight value, and if the sensor measurement error is small, the map creation unit 230 assigns a large weight value.

For example, the map creation unit 230 calculates a value of each grid in the map created in step S503 as the sum of the weights associated with the sensor measurement value group included in the grid. As a result, the influence of the sensor measurement error can be more accurately reflected in the map creation.

In addition, in the first embodiment, although the map creation unit 230 determines whether or not to use the sensor measurement value for map creation based on the sensor measurement error, the present embodiment is not limited thereto. The map creator 230 may generate the sensor measurement value according to the material ID instead of the sensor measurement error.

For example, the map creation unit 230 need not use the sensor measurement value corresponding to the material ID of glass and the like for map creation, and may use the material ID of wallpaper and the like for map creation. As a result, in the initialization process of step S400, it suffices if only the usage and non-usage for map creation for each of the material IDs is held, and it is not necessary to obtain detailed sensor measurement error information.

In addition, in the first embodiment, although it has been explained that the building structure information managed by the building structure information managing unit 240 is the BIM information, the present embodiment is not limited thereto. In the present embodiment, the building structure information is not limited to BIM data structure, and may have any data format as long as it holds information on the type of material of the building material, the shape of the building material, and the position of the building material. Additionally, the object for which the information is acquired is not limited to the building material.

In addition, in the first embodiment, although the sensor measurement error information acquired in the initialization process of step S400 is acquired by calculating the ratio of the distance measurement result with respect to the true value, the present embodiment is not limited thereto.

For example, if the sensor measurement error information corresponding to the material IDs is already recognized, the sensor measurement error information may be acquired in the initialization process in step S400. Additionally, if the sensor measurement error is recognized for the type of material, rather than the material ID, the error information may be acquired in the initialization process of step S400.

In addition, in the first embodiment, although the sensor measurement error information is the ratio of the distance measurement result with respect to the true value, the present embodiment is not limited thereto. The sensor measurement error information may be information indicating a measurement characteristics of the sensor. The method of representing the measurement characteristics of the sensor is not limited, and as information that represents the measurement characteristics of the sensor, for example, information of three categories of high, medium, and low measurement sensitivity may be acquired.

In addition, in the first embodiment, although the sensor disposed on the movable apparatus is the 2D LiDAR, the present embodiment is not limited thereto, and the sensor may be a stereo camera or other types of range sensors. In this context, the material distribution acquisition unit 210 acquires distribution information of a material that may cause a measurement error for the sensor 140 disposed in the movable apparatus 130.

For example, if the sensor 140 is a stereo camera, erroneous measurement is likely to occur on glass or a mirror surface as in 2D LiDAR. In addition, the material distribution acquisition unit 210 acquires, as a material, a material that easily causes an error in the matching processing of feature points, such as a repeated pattern.

If the sensor 140 is a distance measurement sensor other than the LiDAR, a material and the like that easily cause an error in a distance measurement method is acquired. For example, if measurement is performed by illuminating pattern light, an object having a pattern similar to that of the illuminated light is likely to cause a measurement error. The material distribution acquisition unit 210 acquires a distribution of the material that may cause a measurement error when the sensor measures the material.

Note that the sensor measurement value acquired by the sensor measurement value acquisition unit 220 is not limited to using the coordinate value of the point at which the laser beam is reflected as the sensor measurement value, which has been explained in the first embodiment.

In the present embodiment, the distance measurement result performed by the sensor 140 may be acquired as it is as the sensor measurement value. The distance measurement result is acquired together with the laser illumination angle with respect to the front of the sensor 140. In this case, when the material ID of the building material is specified in step S500, first the position and orientation of the sensor 140 is calculated.

As a method of calculating the position and orientation, for example, self-position and orientation estimation is performed by SLAM. SLAM is an abbreviation for “Simultaneous Localization and Mapping”. In addition, the position and orientation may be obtained by separately measuring the position and orientation using a sensor, for example, a GPS and a monitoring camera, which is mounted on or not mounted on the movable apparatus 130, and acquiring the measurement value.

The map creation unit 230 defines a straight line connecting the reflection position of the laser light from the sensor 140 based on the position and orientation information of the sensor 140 and the distance measurement result at each illumination angle, and acquires the material ID of the building material that is present on the straight line.

At this time, the map creation unit 230 acquires the material ID of the building material closest to the sensor 140. As a result, it is possible to predict the sensor measurement error of the material affected by the sensor measurement value, and it is possible to create an environmental map with higher accuracy.

### Modification 1

In the present modification, a method for obtaining a measurement error in consideration of a factor other than, in addition to the material, a material that causes a measurement error, for the prediction of a sensor measurement error with respect to a material distribution performed by the map creation unit 230 will be explained.

Although, in some materials, the measurement can be performed with high accuracy if the laser light is perpendicularly applied to the building material, an error may easily occur if the laser light is applied to the building material at an angle. In the present modification, a method in which a sensor measurement error due to a measurement angle with respect to a building material is taken into consideration will be explained. Note that only differences from other embodiments will be briefly explained.

In the present modification, the map creation unit 230 determines the illumination angle of the laser light with respect to the building material at regular intervals for each material ID, obtains the sensor measurement error corresponding to each illumination angle in advance, and creates a sensor measurement error information table.

During the prediction of the sensor measurement error in step S501, the map generation unit 230 calculates the measured values of the sensor measurement values and the illumination angle with respect to the building material. The map creation unit 230 identifies the structure of the building material on which the laser light is reflected from the material distribution in which the coordinate system is aligned.

Next, the map creation unit 230 sets, on the material distribution, a straight line having a length corresponding to the measurement angle and the distance value included in the position and orientation of the sensor 140 and the sensor measurement value. The map creation unit 230 calculates an illumination angle of the laser light by obtaining an angle formed by the structure of the building material and the straight line. The map creation unit 230 obtains a sensor measurement error value from the calculated illumination angle by referring to the sensor measurement error information table of the corresponding material ID.

The above is the map creation method using the sensor measurement error in consideration of the illuminating angle to the reflected building material. According to the present modification, it is possible to predict a sensor measurement error with higher accuracy, and to create a map with higher accuracy.

In the present modification, the map creation unit 230 measures the measurement error corresponding to the illumination angle to the reflected building material in advance, and holds the measurement error as the sensor measurement error information table. However, the present embodiment is not limited thereto, and the measurement error may be calculated each time.

In addition, in the present modification, although the measurement error that takes into account the illumination angle to the reflected building material has been explained, the measurement error may be a measurement error in consideration of the sensor measurement intensity, instead of the irradiation angle. A measurement intensity value can be acquired as the sensor measurement value, in addition to the distance information to the object.

In the case of using a measurement error that takes into account the sensor measurement intensity, this information is used. As the measured intensity becomes stronger, the measurement error becomes smaller. Therefore, the map creation unit 230 may generates a sensor measurement value to be used for map creation based on the measurement intensity.

At this time, the map creation unit 230 may select a sensor measurement value of which the measurement intensity is equal to or greater than a certain value, or may generate a sensor measurement value by multiplying the sensor measurement value by a weight based on the measurement intensity.

Additionally, the map creation unit 230 may obtain a sensor measurement error in consideration of both the illumination angle to the reflected building material and the measurement intensity. Additionally, in a case where a factor that causes a sensor measurement error other than this occurs, the map creation unit 230 may consider this factor. The map creation unit 230 may take into consideration any one of the factors or may consider a plurality of factors.

### Second Embodiment

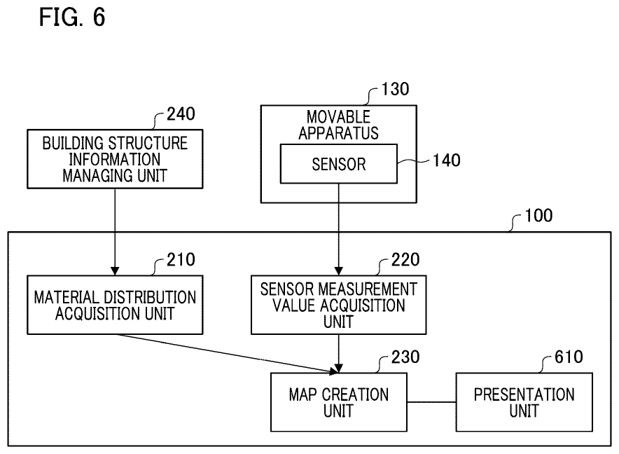

FIG. 6 is functional block diagram of a system according to the second embodiment of the present invention. Note that the functional blocks as shown in FIG. 6 need not be incorporated in the same housing, and may be configured by separate devices connected to each other via a signal path.

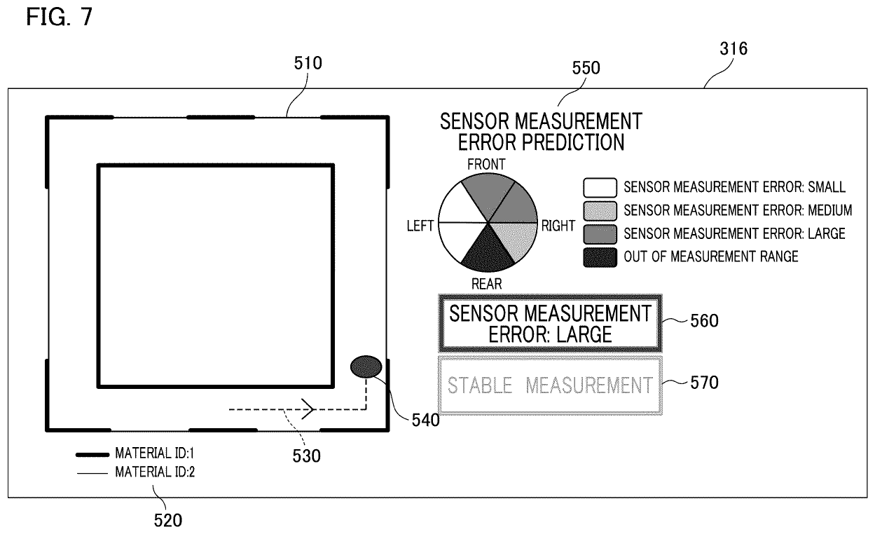

In FIG. 6, the components the same as those in FIG. 2 are denoted by the same reference numerals, and the explanation thereof will be omitted. FIG. 7 is a diagram showing a display example according to the second embodiment of the present invention. FIG. 7 is an example of a GUI displayed on the display unit 102 by the display unit 316. GUI is an abbreviation for “Graphical User Interface”.

In the second embodiment, a method for providing a presentation unit 610 in addition to the configuration of the first embodiment and presenting the predicted sensor measurement error to the user will be explained. The presentation unit 610 executes the processing for displaying the GUI of FIG. 7 on the display device 102 by the display unit 316.

In the second embodiment, as shown in FIG. 7, the display unit 316 displays a material distribution 510 together with a material ID 520. The display unit 316 displays a current position 540 of the movable apparatus 130 and a path 530 along which the movable apparatus has traveled so far, on the material distribution 510.

The display unit 316 displays a distribution 550 related to sensor measurement error predictions in the surrounding portion of the movable apparatus 130 in the current position and orientation in a circular shape. In the second embodiment, the distribution 550 is displayed by dividing the surrounding portion of the movable apparatus into six regions and classifying the predicted values of the sensor measurement errors of each divided region into three groups of large, medium, and small.

The upper side of the circular display of the distribution 550 corresponds to the front of the movable apparatus 130. The predicted values of the sensor measurement errors are classified by using the threshold set in step S501 (FIG. 5) of the first embodiment for determining whether or not to use the predicted values for map creation.

The map creation unit 230 determines that the sensor measurement error is large if the average value of the predicted values of the sensor measurement error of each region is equal to or greater than the threshold, determines that the sensor measurement error is medium if the average value is equal to or greater than a certain percentage of the threshold and less than the threshold, and determines that the sensor measurement error is small if the average value is less than the certain percentage of the threshold. The display unit 316 displays that sensor measurement error is large, the sensor measurement error is medium, and the sensor measurement error is small in the distribution 550.

Among the regions where the sensor measurement error is present, the display unit 316 highlights “the sensor measurement error large” 560 if a certain number or more of regions in which the sensor measurement error is large is present, and highlights “stable measurement” 570 in a case where the number is less than the certain number. In FIG. 7, if there are two or more regions where the sensor measurement error is large, “sensor measurement error: large” is highlighted.

The presentation unit 610 executes processing for displaying the GUI of FIG. 7 on the display device 102 by the display unit 316. The presentation unit 610 causes the display unit 316 to display the distribution of the predicted values of the sensor measurement errors corresponding to the current position and orientation of the sensor while the movable apparatus 130 is traveling, in order to create a map.

If the user confirms this display to recognize the necessity of reducing the sensor measurement error, the user can take a countermeasure of changing the orientation of the movable apparatus to a direction in which the measurement error is smaller.

According to the second embodiment, it is possible to further improve the accuracy in map creation. Note that means for presenting the sensor measurement error to the user is not limited to display on the display device 102 such as a display, and may be presentation accompanied by sound.

At this time, the sound is emitted so that the user notices that the sensor measurement error has increased, for example, a warning sound is emitted only when the sensor measurement error has increased.

The content displayed by the display unit 316 is not limited to the content explained above. The information on the sensor measurement error around the sensor and the information on the location where the sensor measurement error becomes large, which are necessary for the user to add the travel path in which the influence of the sensor measurement error is suppressed, are presented.

Although, in the second embodiment, for example, the predicted values of the sensor measurement error are displayed as a circular distribution, the present embodiment is not limited thereto, and only the direction in which the sensor measurement error is large may be displayed as an arrow.

The display unit 316 may display the directions by words representing directions such as “front” and “front left”, or words representing a bearing including “north side” and “southeast direction”. Additionally, during display of the sensor measurement error, the method of dividing the region around the movable apparatus is also not limited to six equal divisions, and the number of divisions suitable for controlling the movable apparatus 130 may be set.

For example, if the distribution of the material that differs only in one direction is present in the traveling environment of the movable apparatus 130, the display unit 316 may be divided into four equal portions, that is, front and rear, and right and left. In contrast, if the material distribution under the traveling environment is complexly distributed, the display unit 316 increases the number of divisions and performs display so that the direction of the sensor measurement error can be specified in more detail.

Additionally, the words “large sensor measurement error” 560 and “stable measurement” 570 to be highlighted are not limited to these words, and any words may be used as long as the words can be understood to indicate whether the measurement error of the sensor is large or small. It may be possible to recognize the timing when the sensor measurement error is large by changing the color of the whole screen to red only when the sensor measurement error is large.

### Third Embodiment

In the first embodiment and the second embodiment, the sensor measurement error is predicted according to the material distribution in the measured range of the sensor measurement value that has been actually measured, and the measurement result for which sensor measurement error is equal to or larger than a predetermined threshold is not included in the map data, thereby suppressing the influence of the measurement error. In the third embodiment, a measurement error is predicted before sensor measurement is performed, and at least one of measurement position and orientation for map creation is determined so that the measurement error is reduced.

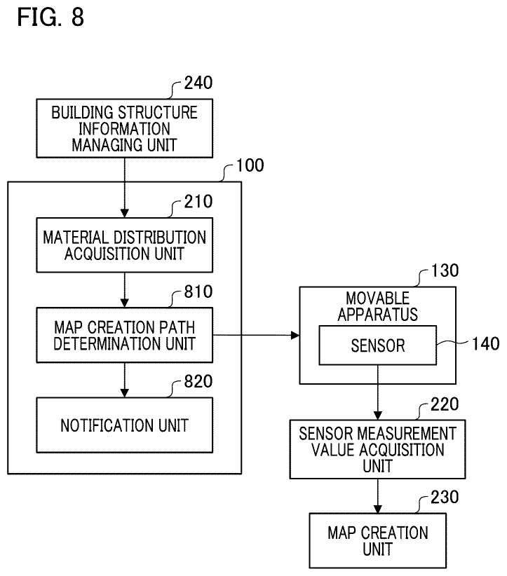

FIG. 8 is a functional block diagram of a system according to the third embodiment of the present invention. In FIG. 8, the same components as those in FIG. 2 are denoted by the same reference numerals, and the explanation thereof will be omitted. The information processing apparatus 100 according to the third embodiment has the material distribution acquisition unit 210, a map creation path determination unit 810, and a notification unit 820. In the third embodiment, the sensor measurement value acquisition unit 220 and the map creation unit 230 are provided outside the information processing apparatus 100.

The material distribution acquisition unit 210 acquires a material distribution in an environment in which the movable apparatus 130 travels. The map creation path determination unit 810 determines a travel path of the movable apparatus for map creation based on the material distribution that has been acquired by the material distribution acquisition unit 210. The map creation path determination unit 810 determines a travel path during map creation based on the material distribution so that the sensor measurement error is reduced during travel of the movable apparatus 130. The notification unit 820 provides notification about the map creation path that has been determined by the map creation path determination unit 810.

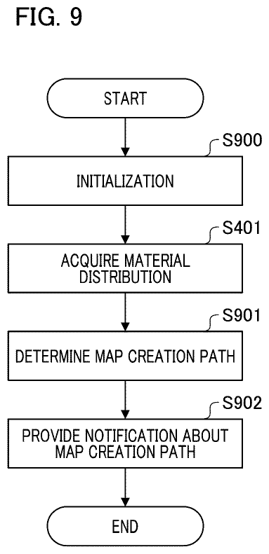

FIG. 9 is a flowchart for explaining the operation of the information processing apparatus 100 according to the third embodiment of the present invention. The information processing apparatus 100 according to the third embodiment starts the operation after the travel path for map creation is planned and before the movable apparatus 130 starts traveling.

In the initialization process of step S900, the information processing apparatus 100 loads a travel path planned in advance for map creation from the external memory 314. The travel path data is data in which a plurality of sets of position data through which the movable apparatus 130 passes and orientation data of the movable apparatus 130 at the position are arranged in order of passage.

Note that the position and orientation in the travel path are both expressed in the coordinate system of a real space. Additionally, in step S900, the information processing apparatus 100 acquires coordinate conversion information indicated by the relative position and orientation between the sensor 140 and the movable apparatus 130.

Additionally, in step S900, the information processing apparatus 100 converts a set of position data through which movable apparatus 130 passes and orientation data of the movable apparatus 130 at the position into a set of position data through which the sensor 140 passes and orientation data at the position.

Following the process of step S900, the process of step S401 is executed. Since the process of step S401 has been explained with reference to FIG. 4, the explanation thereof will be omitted here.

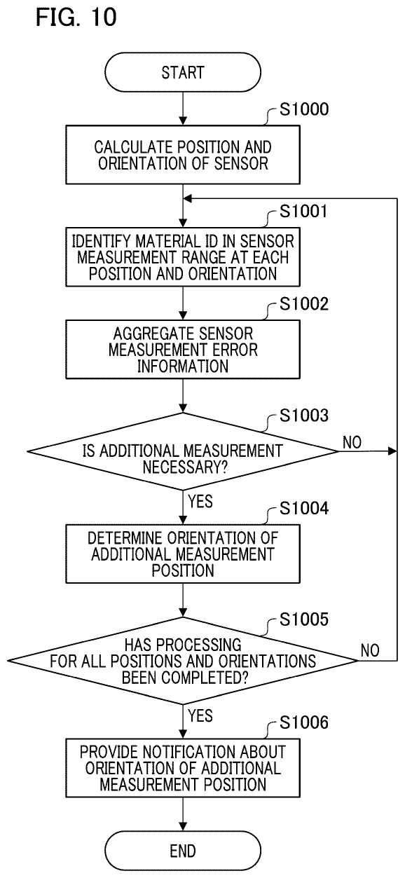

Following the process of step S401, the process of step S901 is executed. In step S901, the map creation path determination unit 810 determines a map creation path based on the material distribution. Details of the process in step S901 will be described below with reference to FIG. 10.

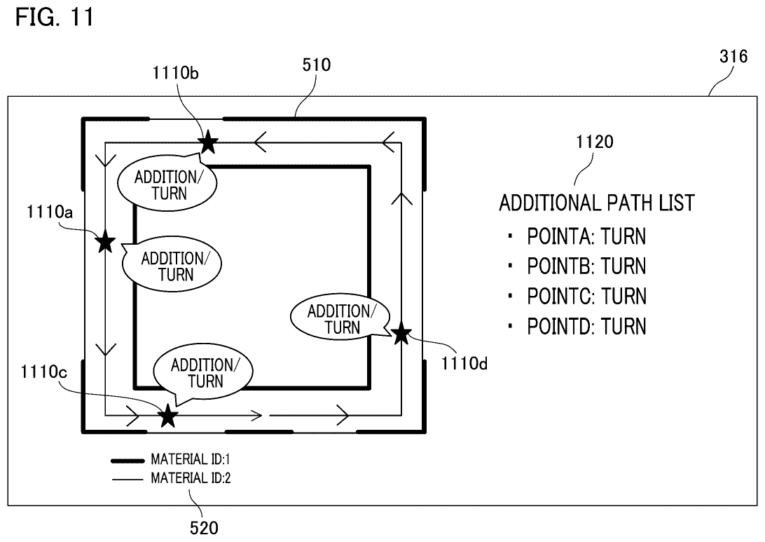

In step S902, the notification unit 820 executes the process of causing the display unit 316 to display the map path determined at step S901 on the display device 102. The display content due to the process in step S902 will be described below with reference to FIG. 11.

FIG. 10 is a flowchart explaining the operation of the map creation path determination unit 810 of the information processing apparatus 100 according to the third embodiment of the present invention. FIG. 10 is a diagram illustrating the details of the process in step S901 of FIG. 9.

In step S1000, among the data of an unprocessed travel path, the map creation path determination unit 810 converts the data of the position and orientation of the head into the position and orientation of the building coordinate system, and calculates the position and orientation of the sensor 140.

In step S1001, the map creation path determination unit 810 specifies all the material IDs of the building materials included in the sensor measurement range in a case where the sensor 140 is disposed at the position and orientation calculated in step S1000.

That is, the map creation path determination unit 810 acquires the material IDs at each measurement angle. If the same material ID is applicable at a plurality of measurement angles, the map creation path determination unit 810 acquires the same material ID a plurality of times.

In step S1002, the map creation path determination unit 810 aggregates sensor measurement error information if sensor measurement is performed at the position and orientation calculated in step S1000. Specifically, for each of the material IDs identified in step S1001, the sensor measurement error information table for each of the material IDs acquired in the initialization process is referred to, the corresponding sensor measurement error information is acquired, and the average is obtained.

In step S1003, the map creation path determination unit 810 determines whether or not sensor measurement other than the position and orientation loaded in step S900 is necessary. Specifically, if the calculation result of step S1002 is equal to or greater than a predetermined threshold, it is determined that additional sensor measurement is necessary. In contrast, if the calculation result of step S1002 is less than the predetermined threshold, it is determined that additional sensor measurement is unnecessary.

In step S1004, the map creation path determination unit 810 changes a travel path for which the plan has been made. In the third embodiment, if it is determined that additional sensor measurement is necessary, a change is performed such that a path of one rotation at the spot is added.

In step S1005, the map creation path determination unit 810 determines whether or not all of the set positions and orientations have been processed. If the map creation path determination unit 810 determines that all the positions and orientations of the sensor 140 have been examined, the process of step S1006 is executed.

If the map creation path determination unit 810 determines that all the positions and orientations of the sensor 140 have not been examined, the process of step S1001 is executed.

In step S1006, the map creation path determination unit 810 provides a notification about the travel path for map creation changed in step S1004 to the notification unit 820. The travel path notified here is obtained by the conversion processing into position data through which the movable apparatus 130 passes and orientation data at the position. In the conversion processing, the coordinate conversion information of the sensor 140 and the movable apparatus 130 acquired in the initialization process is used.

FIG. 11 is a diagram showing an example of a GUI displayed by the notification unit 820 according to the third embodiment of the present invention. The display unit 316 displays the travel path that has been originally planned and the travel paths 1110a to 1110d after change in a superimposed manner so that the added travel path can be recognized.

The above is the processing content of the map creation method determination of step S901.

The map creation path determination unit 810 adds measurement data in different directions at locations where sensor measurement errors easily occur, so that measurement data with less measurement errors can be acquired, and the accuracy of the map can be expected to be improved.

Note that the position and orientation of the traveling path of the sensor 140 obtained in advance may be acquired as the position and orientation of the traveling path of the movable apparatus 130 acquired in the initialization process in step S900.

Although it has been explained that the notification about the traveling path provided by the notification unit 820 is the position data and the orientation data through which the movable apparatus 130 passes, notification about the position data and the orientation data through which the sensor 140 passes may be provided.

Although in the third embodiment, it has been explained that a path of one rotation is added if it is determined that additional measurement is necessary in step S1004, the present embodiment is not limited thereto. The path may be any path that can reduce the sensor measurement error, and the orientation may be changed by 90 degrees, or the direction may be changed by 45 degrees from left to right.

Additionally, as a method of determining a path by the map creation path determination unit 810, the path is determined by a method of adding one path at any location if it is determined that additional measurement is necessary. However, the present embodiment is not limited thereto.

A method of predicting a measurement error by changing the sensor directions by a predetermined angle at each location, repeating the prediction a plurality of times, and adding a sensor direction that is the minimum among the predicted measurement errors may be used. Alternatively, instead of minimizing the sensor measurement error, an angle at which the change angle is small and the sensor measurement error is less than a threshold may be determined.

Additionally, a plurality of sensor directions to be added and sensor measurement errors may be notified together so that the user can select a sensor direction to be added. The user can select the sensor direction taking into consideration the convenience in the control of the movable apparatus.

Note that, although in the third embodiment, in the traveling path acquired in the initialization process, the information on the coordinate point group and the traveling direction is acquired, the present embodiment is not limited thereto. The map creation path determination unit 810 may determine the orientation by an existing path planning technique based on the coordinates of the waypoint group without acquiring the traveling direction.

In addition, in the third embodiment, although it has been explained that the information processing apparatus 100 starts the operation before the movable apparatus 130 starts traveling, the present embodiment is not limited thereto. For example, the movable apparatus 130 may have already started traveling, and in step S900, the calculated position and orientation result during traveling may be used.

In this case, the map creation path determination unit 810 may obtain sensor measurement error information by using an actual sensor measurement value at each position and orientation, calculate a sensor measurement error value, and use the value to determine whether or not additional measurement is necessary.

If it is determined that additional measurement is necessary, the map creation path determination unit 810 provides a notification about the additional measurement direction to the user each time. The information processing apparatus 100 ends the processing flow when he movable apparatus 130 ends the traveling. According to this method, it is possible to reduce an error in map creation even if the traveling path of the movable apparatus has not been planned in advance or the plan has been changed.

### Fourth Embodiment

In the first embodiment, it is assumed that the movable apparatus is a movable robot having a sensor mounted thereon. In the fourth embodiment, an example will be explained in which a head mount display (HMD) worn by a person is used as the movable apparatus.

In the case where the HMD is used as a movable apparatus, an environment map for the movable apparatus to estimate its own position and orientation is created. The functional module configuration and the hardware configuration of the information processing apparatus are similar to those of the first embodiment. Additionally, the processing flow of the information processing apparatus and the processing content of each processing step are the same as those in the first embodiment.

According to the fourth embodiment, it is possible to create an environment map in which the influence of a sensor measurement error is suppressed even if the HMD is used as a movable apparatus.

### Fifth Embodiment

In the second embodiment, a method in which a movable robot is assumed to be the movable apparatus and the sensor measurement error is presented to the user has been explained. In the fifth embodiment, an example in which the HMD worn by a person is used as a movable apparatus will be explained.

The method of determining the content to be presented by the presentation unit 610 and the presentation method are similar to those in the second embodiment. Note that the presentation unit 610 is not limited to presenting the presentation content on a display device that is different from the movable apparatus, for example, the display of the PC, and may display the presentation content on the display of the HMD.

In addition, in a case where the presentation content is displayed on the display of the HMD, a method of displaying the magnitude of the sensor measurement error may be defined in advance, and the defined display method may be superimposed on the CG image and the captured image.

CG is an abbreviation for “Computer Graphics”. Specifically, the surrounding region of the HMD wearer is divided into six regions as shown by the distribution 550 in FIG. 7, and each of the divided regions is indicated by an arrow.

At this time, the predicted values of the sensor measurement errors of the divided regions are classified into three groups of large, medium, and small, and the arrows are displayed in different colors according to the classified groups of large, medium, and small. Alternatively, the HMD display may also be divided according to the divided regions, and a color defined according to the sensor measurement error in each region may be displayed in a transparent color.

According to the fifth embodiment, even when the HMD is used as the movable apparatus, the sensor measurement error can be presented to the user.

### Sixth Embodiment

In the third embodiment, it is assumed that the movable apparatus is a movable robot having a sensor mounted thereon, and a method has been explained for determining at least one of a measurement position and an orientation for map creation such that the sensor measurement error is reduced. In the sixth embodiment, an example in which the HMD worn by a person is used as a movable apparatus will be explained.

Similar to the third embodiment, also in a case where the position and orientation of the HMD are estimated, it is desirable to avoid occurrence of a sensor measurement error depending on the material of the surrounding building material. However, the position and orientation of the HMD cannot be controlled as a movable robot from the outside of the movable apparatus. Therefore, a content for guiding a person wearing the HMD, which is a movable apparatus, to move to a position and orientation with which a measurement error can be reduced is presented.

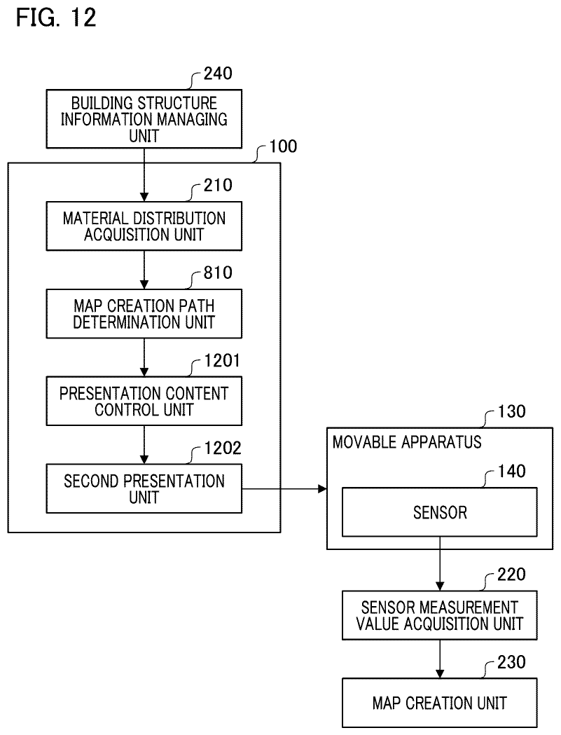

Therefore, as shown in FIG. 12, in the sixth embodiment, a presentation content control unit 1201 that controls the presentation content based on the material distribution acquired by the material distribution acquisition unit 210 is newly provided to control the content to be presented to the HMD wearer.

In addition, a second presentation unit 1202 that presents the presentation content controlled by the presentation content control unit 1201, which is different from the presentation unit 610 included in the configuration of the other embodiments, is provided. Other configurations are the same as those of the other embodiments.

In the sixth embodiment, it is assumed that a recommendation of a way of movement for map creation is determined in advance. That is, as in the third embodiment, it is assumed that a path for map creation has been determined in advance.

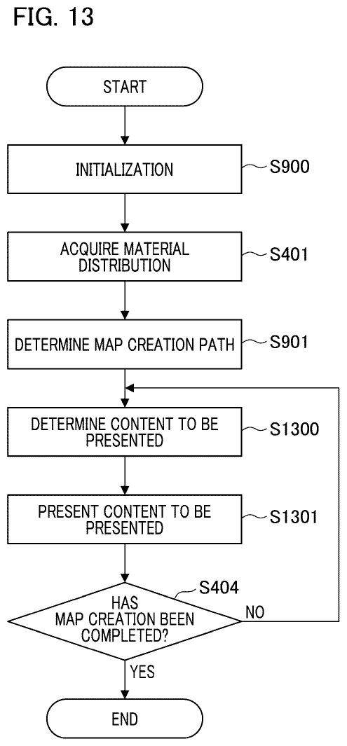

FIG. 13 shows a processing flow in the sixth embodiment. Since the processing content from step S900 to step S901 is the same as that in the third embodiment, the explanation thereof will be omitted.

In step S1300, the presentation content control unit 1201 determines a content to be presented to the HMD wearer based on the map creation path determined in step S901.

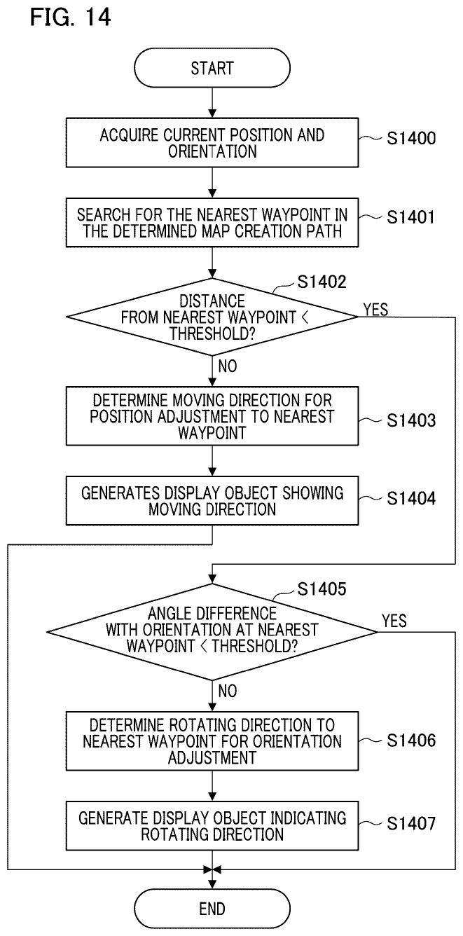

In step S1301, the second presenting unit 1202 presents the presentation content determined in step S1300. The details of the process of step S1300 will be described below with reference to FIG. 14.

In the sixth embodiment, the presentation content control unit 1201 determines to perform a presentation for guiding a position and an orientation such that the map creation path determined in step S901 is obtained. FIG. 14 shows a detailed processing flow of step S1300 in the sixth embodiment.

The presentation content control unit 1201 generates a presentation content for guiding to a waypoint on the path for guiding along the map creation path. In that case, in the movement of the HMD wearer to the waypoint, a presentation content for guiding the HMD wearer to move forward to the position toward the waypoint and then to rotate to adjust the orientation is generated by the presentation control unit 1201.

In step S1400, the presentation content control unit 1201 acquires the current position and orientation information of the HMD wearer. The position and orientation information acquired here is position and orientation information represented by a coordinate system in a real space.

In step S1401, the presentation content control unit 1201 searches for a waypoint nearest to the current position from the waypoint on the map creation path that has been determined in step S901. The presentation content control unit 1201 generates the presentation content for guiding the HMD wearer to the waypoint searched here as below.

In step S1402, the presentation content control unit 1201 determines whether or not the distance from the nearest waypoint searched in step S1401 to the current point is less than a threshold. If the presentation content control unit 1201 determines that the distance from the nearest waypoint to the current point is less than the threshold, the process of step S1405 is executed. If the presentation content control unit 1201 determines that the distance from the nearest waypoint to the current point is equal to or larger than the threshold, the process of step S1403 is executed.

In step S1403, the presentation content control unit 1201 determines a moving direction for adjusting the position so that the HMD wearer moves to the nearest waypoint. Specifically, the presentation content control unit 1201 calculates an amount of change between the position of the nearest waypoint and the current position to obtain an amount of movement, and calculates an amount of orientation change in the direction in which the HMD wearer can move forward when the HMD wearer moves by guidance.

Specifically, the presentation content control unit 1201 calculates the angle of the direction of movement based on the amount of movement in the front-rear direction and the left-right direction with respect to the current forward direction.

In step S1404, the presentation content control unit 1201 generates a display object indicating the moving direction determined in step S1403, and the process ends.

In step S1405, the presentation content control unit 1201 determines whether or not an angular difference between the orientation at the nearest waypoint and the current orientation is less than a threshold value. If the presentation content control unit 1201 determines that the angular difference between the orientation at the nearest waypoint and the current orientation is less than the threshold, the process ends. If the presentation content control unit 1201 determines that the angular difference between the orientation at the nearest waypoint and the current orientation is equal to or larger than the threshold, the process in step S1406 is executed.

In step S1406, the presentation content control unit 1201 determines a rotation direction for adjusting the orientation to the orientation at the nearest waypoint. In step S1407, the presentation content control unit 1201 generates a display object indicating the direction of rotation determined in step S1406 and the process ends.

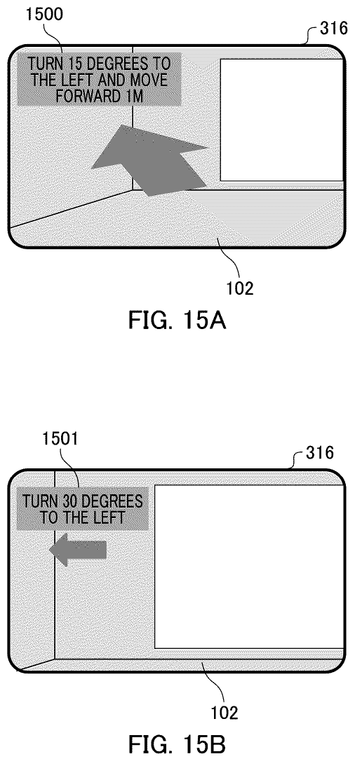

As an examples of presentation on the second presenting unit 1202, an example of presenting the display object generated in step S1404 is shown in FIG. 15A, and an example of presenting the display object generated in step S1407 is shown in FIG. 15B.

The second presenting unit 1202 causes the display unit 316 to display a GUI including a display object 1500 generated in step S1404 based on the moving direction that has been determined by the presentation content control unit 1201 in step S1403, on the display apparatus 102.

In the sixth embodiment, the display device 102 is a display of the HMD. Similarly, the second presenting unit 1202 causes the display unit 316 to display a GUI including a display object 1501 generated in step S1407 based on the rotation direction determined by the presentation content control unit 1201 in step S1406, on the display device 102.

The above is the presentation method in the sixth embodiment. As a result, the influence of the sensor measurement error can be suppressed by presenting to the HMD wearer that the position and orientation in which the sensor measurement error generated according to the material distribution is large should be avoided, and consequently, a map with high accuracy can be created.

Note that although, in the above explanation, the numerical value of the amount of change presented in step S1406 and step S1407 is explained, the present embodiment is not limited thereto. In the present embodiment, the amount of change to be guided may be indicated by the size of the arrow, instead of presenting the numerical value.

### Modification 2

Although in the sixth embodiment, it has been explained that the content controlled by the presentation content control unit 1201 is a presentation for guiding the HMD wearer to a position and an orientation such that the map creation path determined in step S901 is obtained, the present embodiment is not limited thereto.

In the second modification, this point will be explained. In a case where the map creation path determined in step S901 is not obtained even if the presentation of guidance is performed, the presentation content control unit 1201 may provide a presentation of suppressing or interrupting the current movement.

Specifically, it is assumed that the amount of change in the position and orientation of the movement performed after the presentation by the second presenting unit 1202 does not match the amount of change in the position and orientation calculated in step S1403 or step S1406 even after a time equal to or longer than the threshold has elapsed.

In this case, the presentation content control unit 1201 may determine an additional presentation content such that the movement that is currently being performed is suppressed or interrupted. The presentation content control unit 1201 determines that the current movement is interrupted when the change in the position and the orientation of the movable apparatus becomes equal to or less than the threshold after such an additional presentation content is presented.

When the current movement is interrupted, the presentation content control unit 1201 may end the presentation of the additional presentation content, and may determine and present the presentation content for the position and orientation to be guided from the current position and orientation again.

Additionally, in a case where the movable apparatus moves so as to be in the recommended position and orientation, there is a possibility that the movable apparatus moves against the guidance when a rapid movement, for example, an excessively high speed occurs. Even in such a case, the presentation content control unit 1201 may determine an additional presentation content.

The presentation content control unit 1201 may calculate a speed and an angular velocity based on the current amount of movement, and determine that if the speed or angular velocity is equal to or greater than the threshold value, the suppression or interruption of the movement is additionally presented.

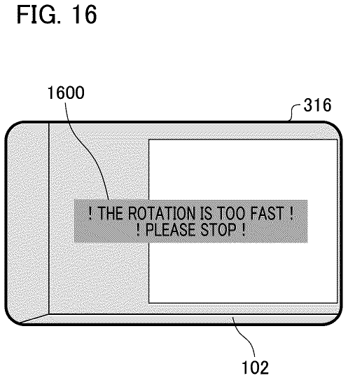

An example of the presentation is shown in FIG. 16. The second presentation unit 1202 causes the display unit 316 to display a GUI including a display object 1600 indicating the interruption of the movement on the display device 102.

In addition, the presentation content control unit 1201 may present a recommended movement and an interruption of movement, and may also present, for example, a warning of an event that occurs due to an increase in an sensor measurement error, for example, an unstable position measurement and unstable operation.

Additionally, the presentation content control unit 1201 may present an alert and a warning regarding the interruption of the movement. For example, the presentation content control unit 1201 may present the screen in a blinking manner when interruption of the movement is determined.

Alternatively, the presentation content control unit 1201 may cause a warning lamp to turn on the display of the HMD. The presentation content control unit 1201 may present the blinking of the screen and the warning lamp only on the screen on the non-recommended position and orientation side.

Additionally, the presentation method is not limited to the guidance display on the display. The recommended position and orientation and the interruption of the movement may be presented by using voice. A warning sound may be generated when the interruption of the movement is presented.

The presentation may be performed by a method of sensing with the sense of touch. When it is desired to interrupt the movement, the presentation may be performed by vibrating the HMD. One of the left and right sides of the HMD may be vibrated to define that the vibrated left or right side is a recommended position and orientation, and the recommended position and orientation may be presented by vibrating one of the left and right sides of the HMD.

In the above explanation, information for guidance, interruption, or suppression is presented separately from a CG image or a captured image that is the object to be observed in a virtual reality (VR) experience and a mixed reality (MR) experience.

However, the present embodiment is not limited to this presentation method, and the display manner of the CG image and the captured image may be adjusted. Specifically, if the sensor measurement error is equal to or larger than a threshold, the transmittance of the CG object may be increased only by a predetermined value.

When the sensor measurement error is equal to or larger than the threshold, the transmittance of the CG object may be changed to be higher as the sensor measurement error becomes larger. Alternatively, the superimposed display of the CG may be stopped when the sensor measurement error becomes equal to or larger than the threshold.

Thus, the person wearing the HMD can intuitively perceive that the position measurement is unstable. Note that the change of the display manner of the CG image and the captured image may be performed in combination with guidance, interruption, or suppression by characters, graphics, sound, and vibration.

Additionally, with respect to the means of presentation, a plurality of presentation means of display, voice, and vibration may be combined for presentation. The combination may be always presented in a plurality of ways. Alternatively, the combination of presentation means may be determined according to the magnitude of the sensor measurement error.

For example, the recommended position and orientation may be presented by being displayed first, and furthermore, a warning sound may be added when the sensor measurement error becomes large. The additional timing is determined by a threshold for the sensor measurement error.

Alternatively, the determination may be made by setting a threshold for the elapsed time from when the HMD wearer deviates from the map creation path that has been determined in step S901. The presentation means may be one of means of display, sound, and vibration, and the presentation may be performed by a plurality of display methods, sound methods, or vibration methods.

In this case as well, it is also possible to always perform the presentation by a plurality of means, or it is also possible to determine the combination of the presentation means by setting a threshold on the sensor measurement error or the elapsed time from the time when the wearer deviates from the map creation path determined in step S901.

### Modification 3

In the sixth embodiment, the method of controlling the presentation content in a case where the path for map creation is determined in advance when the HMD is set as the movable apparatus has been explained.

In the present modification, a method for controlling the presentation content in a case where the map creation path is not determined in advance will be explained. Note that the method described in paragraphs to of the present specification may also be applied to the present modification.

The functional module configuration, the hardware configuration, and the processing steps of the information processing apparatus according to the present modification are similar to those of the sixth embodiment. Note that with regard to the processing contents of the present modification, because the processes from step S900 to step S401 and from step S1300 to step S404 in FIG. 13 are the same as those of the sixth embodiment, the explanation will therefore be omitted.

Additionally, since the presentation content determined by the presentation content control unit 1201 based on the determined path is the same as that of the sixth embodiment, the explanation thereof will therefore be omitted. In this explanation, only step S901, in which the processing content is different, will be explained.

In step S901, the map creation path determination unit 810 determines a map creation path as below. The map creation path determination unit 810 calculates sensor measurement error information by using an actual sensor measurement value at each position and orientation, and determines whether or not additional measurement is necessary.

If it is determined that additional measurement is necessary, the map creation path determination unit 810 predicts a measurement error by changing the sensor direction by a predetermined angle at the current location. The map creation path determination unit 810 repeats this process a plurality of times and adds a sensor direction that is the minimum among the predicted measurement errors.

In addition, instead of minimizing the sensor measurement error, the map creation path determination unit 810 may determine an angle at which the change angle is small and the sensor measurement error is less than the threshold.

The above is the control method of the presentation content in the present modification. As a result, it is possible to guide the movement so as to avoid the sensor measurement error even when the path is not determined in advance.

### Seventh Embodiment

In the first embodiment, the building structure information managing unit 240 acquires material information based on the BIM information of the environment in which the movable apparatus 130 travels. In the seventh embodiment, a map creation method in which a material distribution is determined based on the sensor measurement information instead of BIM information will be explained.

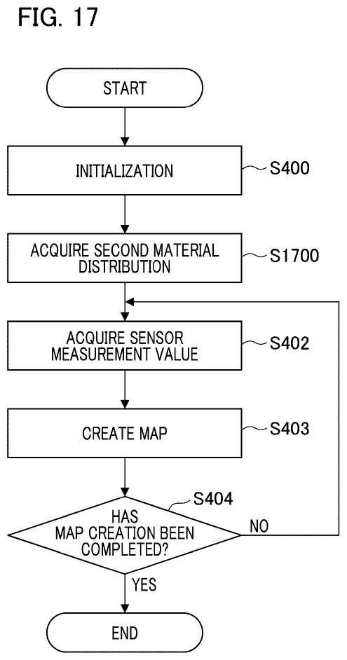

Note that the functional module configuration and the hardware configuration of the information processing apparatus are similar to those in the first embodiment. FIG. 17 shows the processing flow of the information processing apparatus in the seventh embodiment.

In the explanation of each process in FIG. 17, because step S400 and steps S402 to S404 are the same as those in the first embodiment, the explanation thereof will therefore be omitted.

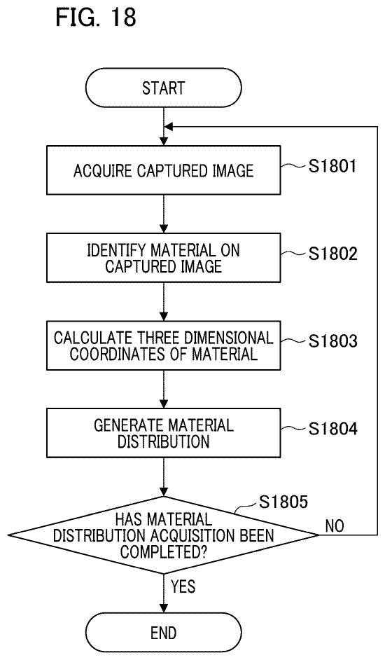

In step S1700, the material distribution acquisition unit 210 acquires the material distribution based on the sensor measurement information managed by the building structure information managing unit 240. In this explanation, details of the process of step S1700 will be explained with reference to FIG. 18.

FIG. 18 shows a detailed processing flow of step S1700 in the seventh embodiment. In step S1801, the material distribution acquisition unit 210 acquires an image obtained by capturing an environment in which the movable apparatus managed by the building structure information managing unit 240 travels.

In the seventh embodiment, the building structure information managing unit 240 manages images of the surroundings of the movable apparatus captured by an image sensor mounted on the movable apparatus at a plurality of points where the movable apparatus moves. At this time, the building material structure information management unit 240 records the position and orientation of the captured point and the captured range in association with the captured image. The captured image managed by the building material structure information management unit 240 is also used for SLAM processing that estimates the position and orientation of the movable apparatus.

In step S1802, the material distribution acquisition unit 210 identifies the material from the captured image, and converts the identified material into material ID. The identification of the material from the captured image is performed by the image recognition technique using a machine learning, similarly to the method described in Japanese patent No. 6,679,188 in which the image processing apparatus determines the material of an unsorted object based on the visible light image.

Note that, in the seventh embodiment, a building material image is input in the learning mode, material information of each building material is input as a correct answer, calculation is performed, and material information included in each photographed image is machine-learned.

In addition, image recognition is performed on the captured image managed by the building structure information managing unit 240 using the learning data that has been machine-learned, and the material included in the captured image is identified together with the position on the captured image.

At the time of image recognition using the learning data, the identified material is designated by a bounding box on the image. The center coordinates of the bounding box are set as the position of the material on the captured image, and the size of the bounding box is set as the size of the material.

In step S1803, the material distribution acquisition unit 210 calculates the three dimensional coordinates of the material. The material distribution acquisition unit 210 searches for a feature point on the captured image nearest to the position of the material on the captured image using the position information of the material on the captured image obtained in step S1802.

The material distribution acquisition unit 210 obtains the three dimensional coordinates of the searched feature point by the SLAM processing. Thus, the three-dimensional coordinates of the material can be obtained.

In step S1804, the material distribution acquisition unit 210 generates a material distribution from the three dimensional coordinates of the material. Specifically, the material distribution acquisition unit 210 defines a two-dimensional material distribution space represented by width and depth.

The material distribution acquisition unit 210 divides the material distribution space into grids, and inserts material ID into the grids in which the materials is present based on the sizes of the material obtained in step S1802 and the material three dimensional coordinates obtained in step S1803, thereby creating a material distribution.

In step S1805, the material distribution acquisition unit 210 determines whether or not all the material distributions of the traveling environment of the movable apparatus have been acquired. If the material distribution acquisition unit 210 determines that all the material distributions have been acquired, the process ends.

If the material distribution acquisition unit 210 determines that all the material distributions have not been acquired, the process returns to step S1801 and the process is repeated. With respect to the determination of whether or not all of the material distribution can be acquired, the material distribution acquisition unit 210 determines all the material distributions have been acquired if a blocked regions is formed in the two-dimensional material distribution space in the traveling environment.

The above is the method for acquiring the material distribution in the seventh embodiment. Thus, it is possible to acquire and manage the building structure information even if there is no BIM information of the traveling environment.

Note that, although it has been explained that the process returns to step S1805 if the material distribution cannot be acquired in step S1801, the present embodiment is not limited thereto. The material distribution acquisition unit 210 may acquire all the captured images in advance in step S1801, and the process may return to step S1802 for the repetition processing.

Note that, although it has been explained that the material distributions generated in step S1804 are generated by defining a two dimensional material distribution space, the present embodiment is not limited thereto. The material distribution acquisition unit 210 may define a three-dimensional material distribution space.

Also in this case, the determination as to whether or not the material distribution in step S1805 has been acquired may be made by determining whether or not a closed space has been formed in two dimensions of the width and the depth. Alternatively, the material distribution acquisition unit 210 may define a two dimensional or three-dimensional material distribution space and create a material distribution, and then convert the material distribution into a parameter representing the shape of each material and its material ID, similar to the material distribution acquired in the first embodiment.

Note that, although it has been explained that specifying by image recognition using machine learning is the method for identifying the material included in the captured image, the present embodiment is not limited thereto. The material distribution acquisition unit 210 may identify a material based on reflection characteristics in different wavelengths by using an image captured by using a multispectral camera.

Note that, although it has been explained that the captured images are captured at a plurality of points where the movable apparatus moves, the present embodiment is not limited thereto. The material distribution acquisition unit 210 may use images captured at the same position while changing only the orientation, instead of images captured in a plurality of positions.

If the moving range of the movable apparatus is limited, such as to the same room, the material distribution can be obtained only from images captured at the same position in a plurality of orientations.

Additionally, although it has been explained that the captured images are captured by the sensor mounted on the movable apparatus, the image may be captured by a sensor not mounted on the movable apparatus. The material distribution acquisition unit 210 may use an image captured by a sensor mounted on another movable apparatus or may use an image captured by a fixed sensor including a monitoring camera.

The material distribution obtaining unit 210 may calibrate the position and the orientation of the monitoring camera in the coordinate system of the building structure in advance and obtain the distribution range of the material from the monitoring camera. The material distribution acquisition unit 210 may separately acquire the shape information of the region in which the monitoring camera managed by the building structure information managing unit 240 is installed, and combine the shape information with the material distribution from the monitoring camera to obtain the material distribution in the region.

Since the material distribution is used to predict a sensor measurement error value, machine learning may be performed by using the sensor measurement error value directly instead of the material ID. That is, although it has been explained that the photograph of building material and the material ID are input and calculated during machine learning, the photograph of building material and the sensor measurement error value of the building material may be input, and machine learning may be performed.

In this case, the sensor measurement error value is measured at the same time when the photograph of building material is imaged, and the measurement result is used for learning. Additionally, machine learning may be performed by using information on the presence or absence of use in map creation instead of the material ID so that whether or not to use the sensor measurement value for map creation based on the sensor measurement error value is determined.

Note that, although it has been explained that the map creation path determination unit 810 predicts a sensor measurement error value based on the material distribution, the present embodiment is not limited thereto. The map creation path determination unit 810 acquires architectural drawing information, compares a depth measurement value predicted based on the architectural drawing, a measurement value of a sensor capable of measuring the depth information, and the architectural drawing information, and compares the architectural shape obtained from the depth information and the architectural drawing.

The map creation path determination unit 810 may determine that the sensor measurement value is not used for map creation if there is a difference equal to or greater than a threshold in the comparison. In this method, it is possible to determine the magnitude of the sensor measurement error based on the architectural drawing without the building material information.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the information processing apparatus and the like through a network or various storage media. Then, a computer (or a CPU, an MPU, or the like) of the information processing apparatus and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

What is claimed is:

1. An information processing apparatus that creates a map of an environment in which a movable apparatus moves comprising:
one or more memories storing instructions; and
one or more processors executing the instructions:
to acquire a material distribution in an environment in which the movable apparatus moves;
to acquire a measurement value measured by a sensor disposed on the movable apparatus; and
to create a map of the environment based on the measurement value and the material distribution.

2. The information processing apparatus according to claim 1, wherein, during creation of the map, a material of an object included in a spatial region corresponding to the measurement value is identified, a magnitude of an error of the measurement value is estimated based on the identified material, and a map value related to a spatial region corresponding to the measurement value is set based on the estimated magnitude of the error.

3. The information processing apparatus according to claim 2, wherein, during creation of the map, if the magnitude of the error is less than a predetermined threshold, a value indicating that an object is present is set as a value of a map related to a spatial region corresponding to the measurement value.

4. The information processing apparatus according to claim 2, wherein, during creation of the map, a value corresponding to the magnitude of the error is set as a map value related to a spatial region corresponding to the measurement value.

5. The information processing apparatus according to claim 1, wherein the one or more processors further executing the instructions to present information on an error distribution of the measurement value with respect to an orientation of the movable apparatus.

6. The information processing apparatus according to claim 5, wherein the one or more processors further executing the instructions to control a presentation content based on the material distribution, and present the presentation content.

7. An information processing apparatus that determines a path to be travelled for creating a map of an environment in which a movable apparatus moves comprising
one or more memories storing instructions; and
one or more processors executing the instructions:
to acquire a material distribution in an environment in which the movable apparatus moves;
to determine a travel path for map creation based on the material distribution; and
to provide notification about information on the travel path.

8. The information processing apparatus according to claim 7, wherein if an error of a measurement value measured by a sensor disposed on the movable apparatus is equal to or greater than a predetermined threshold during determination of the travel path, a path for changing an orientation of the movable apparatus is added to the travel path.

9. A method of creating a map of an environment in which a movable apparatus moves, the method comprising:
acquiring a material distribution in an environment in which the movable apparatus moves;
acquiring a measurement value measured by a sensor disposed on the movable apparatus; and
creating a map of the environment based on the measurement value and the material distribution.

10. A method of determining a path to be travelled for creating a map of an environment in which a movable apparatus moves, the method comprising:
acquiring a material distribution in an environment in which the movable apparatus moves;
determining a travel path for map creation based on the material distribution; and
providing notification about information on the travel path that has been determined.

11. A non-transitory computer-readable storage medium configured to store a computer program comprising instructions for executing following processes:
acquiring a material distribution in an environment in which a movable apparatus moves;
acquiring a measurement value measured by a sensor disposed on the movable apparatus; and
creating a map of the environment based on the measurement value and the material distribution.

12. A non-transitory computer-readable storage medium configured to store a computer program comprising instructions for executing following processes:
acquiring a material distribution in an environment in which a movable apparatus moves;
determining a travel path along which the movable apparatus travels for map creation of the environment, based on the material distribution; and
notifying information on the travel path that has been determined.
